(19) United States
(12) Patent Application Publication
(10) Pub. No.: US 2008/0296210 A1
(43) Pub. Date: Dec. 4, 2008

(54) FLUID TREATMENT DEVICES

(76) Inventor: Gene BITTNER, Sarasota, FL (US)

Correspondence Address: BERENATO, WHITE & STAVISH, LLC, 6550 ROCK SPRING DRIVE, SUITE 240, BETHESDA, MD, 20817, US

(21) Appl. No.: 12/189,991

(22) Filed: Aug. 12, 2008

Related U.S. Application Data
(63) Continuation-in-part of application No. 11/192,376, filed on Jul. 29, 2005, now Pat. No. 7,413,649.

(51) Int. Cl. B01D 35/147; B23P 19/04; B01D 35/28; B01D 35/157

(52) U.S. Cl. 210/133; 29/213.1; 210/438; 210/137; 210/136

(57) ABSTRACT

A fluid treatment device includes at least one treatment module (“pod”) releasably connected to a head unit, the pod and head unit each including riser tubes which may be connected to adjacent riser to form a flow passage through the fluid treatment device. A connection mechanism allows a control valve to be rotatably connected to a fluid treatment device so that it may be oriented as desired.

### REFERENCE TO RELATED APPLICATIONS

This application is a continuation-in-part of U.S. application Ser. No. 11/192,376, filed Jul. 29, 2005.

### BACKGROUND OF THE INVENTION

1. Field of the Invention

The present disclosure relates to fluid treatment devices, and more particularly to a modular fluid treatment device in which a treatment module includes a riser tube that is connected to a riser tube included in a head unit to form a flow passage through the fluid treatment device. The disclosure also relates to connecting arrangements for connecting control valves to fluid treatment devices and to valve apparatuses for introducing compressed air into fluid treatment devices.

2. Description of the Prior Art

The fluid treatment process involves removing a variety of undesirable contaminants from a fluid source. The removal of each of the contaminants may require a different process, including both mechanical and chemical filters. Prior art fluid filtering systems have addressed the problem of multiple and different fluid contaminants in a variety of ways.

The most basic system involves simply depositing different types of purifying media in a single containment tank, and then directing fluid through the tank. The “media” may include any physical material used in standard fluid treatment practice, including, but not limited to, cation exchange resins, carbons, filter sands, deionization resins, catalysts, pH adjusters, and the like. While this type of treatment is relatively simple to perform, the media generally do not form a homogenous mix so that all the fluid directed through the tank may not be uniformly exposed to each type of media within the tank. Fluid within the tank frequently forms channels around the densest media so that the fluid produced from the process is not consistently treated and consequently may still retain undesirable contaminants. If the various treatment media in the fluid treatment containment tank are thoroughly mixed, the individual media may break down or become diluted and ineffective. Additionally, removing some specific types of contaminants requires a specific treatment sequence, which is not possible in a single open-tank type system. Further, in a treatment system with mixed media, it is essentially impossible to effectively remove and replace only one type of media, without replacing all the media.

To ensure that all the water is consistently treated and the treatment media is not diluted or destroyed, multi-tank systems have been developed that have an individual tank dedicated to each type of media, so that the fluid is directed through a series of sequential treatment tanks. While this type of treatment system offers some advantages, it is also relatively expensive and requires a significant amount of space and resources to construct. Further, a multi-tank system includes a network of valves, piping, and tanks that must be periodically cleaned and maintained. As a result of these and other limitations, multi-tank systems are generally practical for only high-volume users with significant resources.

Treatment system manufacturers have attempted to address these concerns by designing systems for relatively low volume users that have a single tank, but also include multiple individual layers of media arranged within the tank so that fluid flows sequentially through each layer. While these types of systems are an improvement over previous systems, the layered systems are still relatively inflexible. The different types of filter media comprising the layering system are consumed by the filtration process at differing rates. To remove and service a specific target layer, the layers above the target layer must be individually removed from the tank, and then reinstalled after the target layer has been serviced and prior to re-starting operation.

Alternatively, the entire layered system can be serviced at once by “backwashing” the system, however, because all of the fluid injected into the system must pass through all of the media layers before the fluid can be extracted, sediment removed from the lower layers is frequently redeposited in the system's upper layers before the fluid flows out of the treatment device.

### SUMMARY OF THE INVENTION

In accordance with an embodiment, a fluid treatment device comprises at least one fluid treatment pod having a rigid and impermeable outer wall and a rigid and impermeable inner wall defining an opening extending through an interior portion of the pod, a first rigid and impermeable riser tube extending through the opening, and a treatment media disposed in the pod interior portion, and a hollow head unit having a second rigid and impermeable riser tube extending through an interior portion of the head unit, wherein the second riser tube is connected to an upper portion of the first riser tube to form a flow passage through the fluid treatment device.

In accordance with another embodiment, a connecting arrangement for rotatably connecting a control valve to a fluid treatment device comprises a yoke including an internally threaded sleeve for receiving a threaded control valve stem, a riser tube extending through the sleeve, and a lip surrounding the sleeve, the lip comprising a first portion and a second portion, the first portion having an outer diameter greater than an outer diameter of the second portion, and a threaded collar including a flange extending inwardly and defining an aperture through which the threaded sleeve extends, the flange engaging the lip first portion when the collar is threadedly connected to the fluid treatment device.

In accordance with yet another embodiment, a valve apparatus for introducing compressed air into a fluid treatment device comprises a housing, a compressed air inlet valve allowing compressed air to be selectively directed into the valve apparatus, a pressure relief valve for selectively releasing air from the valve apparatus, and a one-way valve for controlling the movement of fluid out of the valve apparatus.

In accordance with yet another embodiment, a flow diversion element for controlling a flow path in a fluid treatment device comprises an annular disk having an inner circumference and an outer circumference and a top surface and a bottom surface, a plurality of fins extending from the top surface to the bottom surface and defining a plurality of flow passages through the disk, each of the fins extending from the inner circumference or the outer circumference in a radial or tangential direction different from the radial or tangential direction of at least one other fin.

The presently disclosed fluid treatment devices offer numerous advantages over conventional fluid treatment devices. For example, the presently disclosed fluid treatment devices are extremely flexible and allow a user to easily and effectively customize a fluid treatment process for a particular need. A variety of types of fluid treatment media may be utilized in the disclosed devices, alone or in various combinations, and the media may be easily removed and replaced with minimal disassembly of the device. Furthermore, increased contact between the fluid and fluid treatment media allows for more effective removal of contaminants and more thorough fluid treatment. Additionally, the presently disclosed connection arrangements allow control valves to be connected to fluid treatment devices and consistently oriented in any desired direction. The presently disclosed valve apparatuses for introducing compressed air advantageously simplify the process of servicing fluid treatment devices while ensuring that the devices are not overpressurized. Additional advantages, as well as additional inventive features will be apparent from the description of the invention provided herein.

### BRIEF DESCRIPTION OF THE DRAWINGS

FIG. 1 is a perspective of an embodiment of a fluid treatment device;

FIG. 2 is an isometric view of a wafer disk;

FIG. 3 is an exploded sectional view of a head unit, fluid treatment pod, and base unit;

FIG. 4 is an isometric view of a pod;

FIG. 5 is an isometric view of the underside of a pod;

FIG. 6 is a sectional view of a valve assembly installed in a pod;

FIG. 7 is a sectional view of an individual valve in the closed position;

FIG. 8 is a sectional view of an individual valve in the open position;

FIG. 9 is a perspective of an embodiment of a compressed air inlet valve;

FIG. 10 is a perspective of another embodiment of a compressed air inlet valve.

### DETAILED DESCRIPTION OF PREFERRED EMBODIMENTS

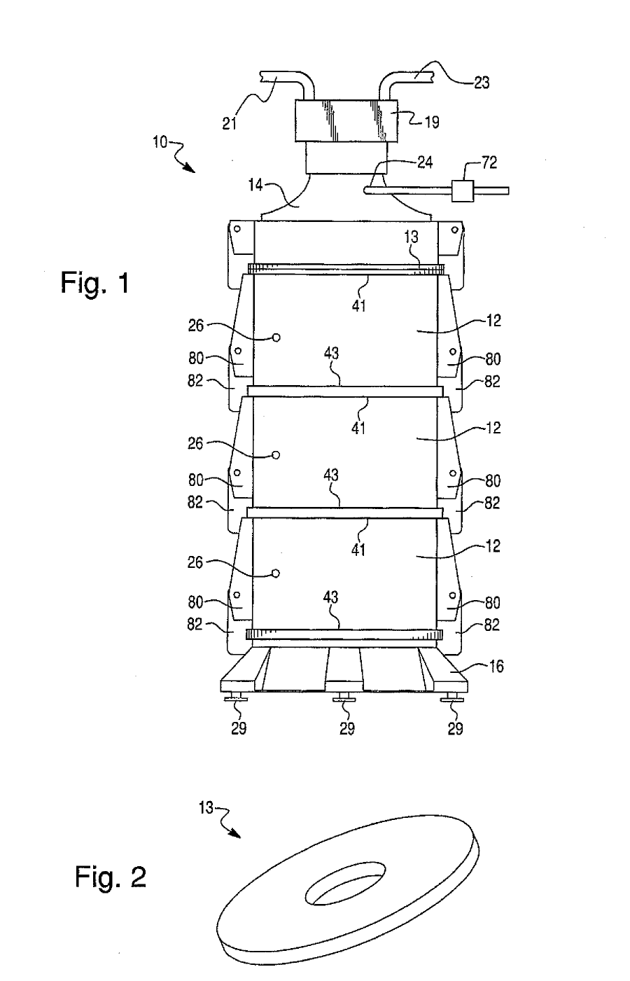

Fluid treatment devices according to the present disclosure may be variously configured. The embodiment shown in FIG. 1 comprises a stand-alone water treatment device 10. The device 10 is comprised of three or more components including at least one individual treatment tank or “pod” 12, a head unit 14, and a base unit 16. The pod 12 is disposed between the head unit 14 and the base unit 16. In the embodiment shown in FIG. 1 the treatment device 10 includes three pods 12; however, the device 10 may include more than three or fewer than three pods 12, as desired for a specific treatment application. The pods 12 are vertically aligned and self-supporting, which means that the pods require no auxiliary support to remain in an upright vertical position. The head unit 14 is connected to a top portion of the uppermost pod 12, and the base unit 16 is connected to a bottom portion of the lowest pod 12. A control valve arrangement 19 controls the flow of fluid into the device 10 through a fluid inlet line 21, and also controls the flow of the fluid out of the device 10 through the fluid outlet line 23.

In some embodiments, one or more optional wafer disks may be positioned within the device to provide basic mechanical filtration. For example, the treatment device may include one, two, three, four or even more wafer disks. The wafer disks may be positioned between any of the pods and may be formed with the same or different filtration ratings. In an embodiment shown in FIGS. 1 and 2, an optional wafer disk 13 may be positioned above the uppermost pod 12 to provide basic mechanical filtration.

The wafer disks may be variously configured. For example, the wafer disks may comprise a porous substrate, such as a porous membrane or woven or nonwoven fibrous layer, and a structural support. In an embodiment, the wafer disks may comprise a nonwoven filter and a structural support. For example, a nonwoven filter may be reinforced by a first support disk or may be sandwiched between first and second support disks. The first and second support disks may connect to one another in a variety of ways, for example, using a plurality of pins and corresponding holes around the disk perimeter.

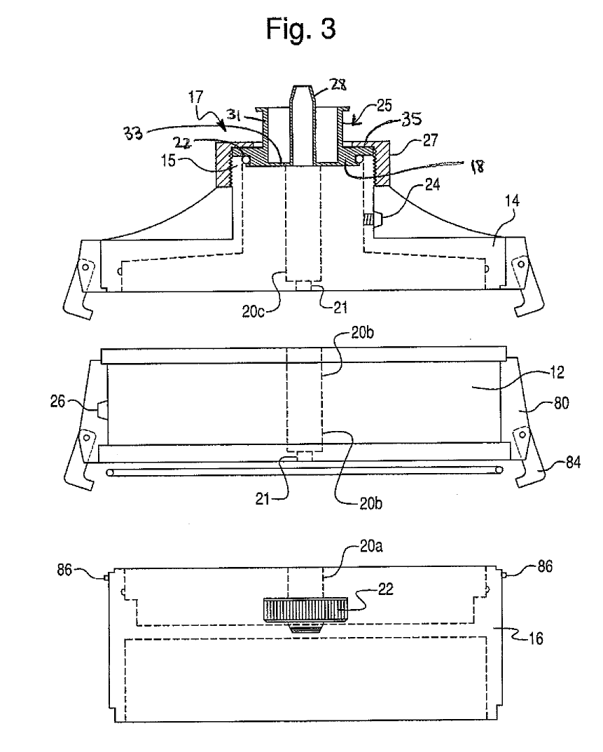

As best shown in FIG. 3, the base unit 16, pod 12, and head unit 14 each include a riser tube 20a, 20b, 20c, respectively. In many embodiments, the riser tubes 20a, 20b, 20c are integrally formed in each of the base unit 16, pod 12, and head unit 14, respectively. Alternatively, the riser tubes 20 may be screwed or otherwise connected to the base unit 16, pod 12, and head unit 14. The riser tubes 20 may be configured so that they may be connected to adjacent riser tubes 20 to form a single riser extending from the base unit 16 through the pods 12 and the head unit 14 and out an opening 17 in the top of the head unit. For example, the base unit riser tube 20a may be connected to a lower portion of the riser tube 20b in the lowest pod. The top portion of a pod riser tube 20b may be connected to the lower portion of an adjacent pod riser tube 20b or if the pod is the uppermost pod, to the lower portion of the head unit riser tube 20c. Connecting the integrally formed riser tubes of the individual components to form a single riser extending through the entire device advantageously allows a riser of any desired height to be formed. Additionally, the need to add a longer riser whenever the height of the device is changed, e.g., when additional pods are added, is avoided.

The riser tubes 20 may be connected to one another using any of a variety of connection mechanisms. In some embodiments, the riser tubes are connected to one another with a friction fit. For example, as best seen in FIG. 3, the lower portion of each riser tube 20 may include a seal 21 which includes a first portion which fits inside the lower portion of the riser tube 20 and a second portion which protrudes from the lower portion of the riser tube 20. To connect two riser tubes, the protruding portion of the seal 21 is fitted inside the upper portion of an adjacent riser tube to form a fluid tight seal between the two riser tubes 20. For example, the seal 21 may comprise an annular elastomeric gasket or O-ring that fits inside the riser tubes 20. In the basic fluid treatment sequence, treated fluid enters and flows through the base unit riser tube 20a, into the adjacent connected pod riser tube 20b, into the riser tubes 20b of any additional pods, and then into the head unit riser tube 20c and is extracted from the riser, as directed by the control valve arrangement 19 (shown in FIG. 1) at the top of the device 10.

As best shown in FIGS. 1 and 3, the head unit 14 is essentially a hollow housing that allows untreated fluid from the fluid inlet line 21 to flow or be sprayed across the surface of the uppermost pod 12 or the wafer disk 13. The head unit 14 may include an opening 17 that accommodates at least the head unit riser tube 20c, the inlet line 21, and the outlet line 23 (shown in FIG. 1). In many embodiments, the head unit 14 may also include a connection mechanism for connecting the device 10 to a control valve arrangement 19. A connection mechanism may have a variety of configurations. For example, the connection mechanism may comprise internal threads in opening 17 which may receive the threaded stem of a control valve arrangement. The threads and opening 17 may accommodate any standard control valve arrangement and a number of standard control valves are available in the industry. In other embodiments, the connection mechanism may allow the control valve arrangement to rotate, for example to rotate up to 360° so that it may be consistently oriented as desired, for example to the front of the device 10. For example, the control valve arrangement 19 may be connected to a member that is rotatably disposed in the head unit and a locking mechanism may engage the member and head unit to prevent further rotation when the control valve arrangement 19 reaches the desired position.

In an embodiment illustrated in FIG. 3, a control valve arrangement 19 may be connected to a yoke 25, for example, threadedly connected, and the yoke may be rotatably positioned in the opening 17 in the head unit 14. For example, the yoke 25 may include a threaded sleeve 31 for receiving a threaded control valve stem and a riser tube 28 extending through the yoke 25 which connects the control valve riser tube to the head unit riser tube 20c. The yoke 25 may also include an outwardly extending lip surrounding the sleeve 31 including a first portion and a second portion. The first portion 22 may have an outer diameter that is greater than the inner diameter of the opening 17 and the second portion 18 may have an outer diameter that is less than the inner diameter of the opening 17, so that the first portion may be seated on the fluid treatment device at the opening 17 when the second portion 22 is positioned within the opening 17. In many embodiments, the yoke may include a barrier to flow 33 surrounding the riser tube 28, for example, within the sleeve 31, so that fluid may flow through the yoke 25 only via the riser tube 28. In many embodiments, the device may further include a locking mechanism that, when engaged, may prevent rotation of the yoke. For example, in operation, a control valve may be connected to the yoke and the yoke 25 may be rotated until the control valve arrangement 19 reaches the desired position, e.g., oriented toward the front of the device. The locking mechanism may then be engaged with the yoke 25 to prevent further movement of the control valve arrangement 19. The locking mechanism may be variously configured. In the embodiment illustrated in FIG. 3, the locking mechanism may comprise a threaded collar 27 including a flange 35 extending inwardly and defining an aperture through which the threaded sleeve 31 extends. The collar 27 may include threads corresponding to external threads on the fluid treatment device at the opening 17. In operation, the yoke 25 may be positioned with the lip second portion in the opening 17 and the lip first portion 22 seated on the fluid treatment device and the collar may be positioned around the yoke 25 and fluid treatment device 10. The collar 27 may be rotated into a locking engagement with the device 10 so that the flange 35 engages the lip first portion 22 and prevents rotation of the yoke 25.

In some embodiments, the head unit 14 also may include a compressed air inlet tap 24 which may be used in servicing the pod 12. For example, compressed air may be introduced via the compressed air inlet tap 24 to drive treated and/or untreated water out of the device prior to service. The compressed air inlet tap 24 may communicate with an upstream side of the fluid treatment device 10, e.g., the inlet fluid side. Compressed air introduced via the air inlet tap 24 may drive fluid downwardly along a fluid treatment path through the device and then upwardly through the connected riser tubes and out through the fluid outlet 23. The air inlet tap advantageously allows for fluid to be effectively and efficiently removed from the device without requiring draining and siphoning. Removing the fluid prior to servicing the device, reduces the weight of the device, simplifies many servicing processes and allows for easier transporting of a device or tank.

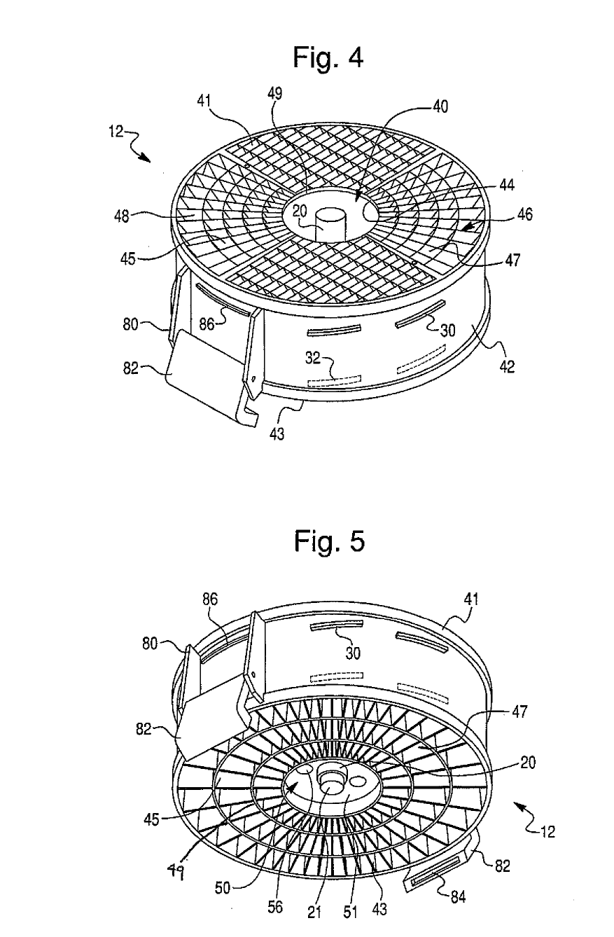

The individual pods may have a variety of configurations. As best seen in FIGS. 4 and 5, in many embodiments, the individual pods 12 are circular and comprise an outer wall 42, an interior wall 44, and a riser tube 20b which may be formed in the center of the pod 12. The riser tube 20b and interior wall 44 form an interior annular channel 40 extending through the center of the pod 12. In many embodiments, the riser tube 20b, outer wall 42, and interior wall 44 are rigid and impermeable so that the pods 12 may be stacked vertically with no other exterior means of support required. As best seen in FIG. 4, the outer wall 42 and interior wall 44 form an annular treatment portion 47 which may contain a fluid treatment medium 45.

A variety of fluid treatment media may be utilized in the device. For example, the fluid treatment media may comprise filter sands, antibacterial agents, chlorine removal agents, ion exchange resins, catalysts, UV modules, nanofiltration membranes, and/or pH adjusters. In some embodiments, the media may be semi-solid, e.g., granular or particulate and may be maintained within the treatment portion 47 of the pod 12 by a containment system that is specific to the type of treatment media within the pod 12. For example, a containment system may comprise a flexible, porous member formed from any of a variety of materials. In some embodiments, the porous member may comprise a fibrous woven or non-woven material. In other embodiments, the media may be otherwise configured. For example, the media may comprise a porous membrane, such as a nanofiltration membrane and/or one or more UV rods positioned across the annular treatment portion 47.

In many embodiments, the pods 12 may include a directional flow disk 46 which may direct fluid flow across the pods 12 and provide a foundation support for the pods 12. Advantageously, the directional flow disk 46 directs the fluid in a combination axial/radial direction, rather than a purely axial direction, and may increase the contact time between the fluid the treatment media. In many embodiments, the directional flow disk 46 includes a plurality of fins 48 which extend in varying radial and tangential directions. For example, fins 48 may be oriented concentrically with the perimeter of the pod, extend radially, extend parallel to one or more bi-sections of the pod or extend in random directions. In an embodiment best seen in FIG. 4, the directional flow disk 46 may be divided into quadrants, and each quadrant may include fins 48 extending in two differing directions. Additionally, the fins 48 in at least one quadrant may differ in their orientation from the fins 48 in another quadrant. For example, at least one quadrant may include a plurality of fins 48 oriented concentrically with the perimeter of the pod and a plurality of fins 48 radiating from the center of the pod. In another quadrant, a first plurality of fins 48 may be oriented parallel to a first bi-section of the pod and a second plurality of fins 48 may be oriented parallel to another bi-section of the pod and perpendicular to the first plurality of fins 48. In an alternative embodiment, the pods 12 may have any shape known in the art, and the directional flow disk 46 may have alternative configurations specific to the treatment media within the pod 12.

In many embodiments, the pods 12 may also include a support positioned at the bottom of the pod. For example, as seen in FIG. 5, the pods 12 may include a support disk 49 positioned on the bottom of the pod 12 to provide additional structure and support for the fluid treatment medium 45. The support disk 49 may have any configuration, but preferably does not significantly impede flow through the pod 12. In one embodiment shown in FIG. 5, the support disk 49 may include a web configuration including concentrically oriented and radially oriented support fins. However, other orientations are also possible. For example, in some embodiments the support disk 49 may include a plurality of fins oriented as in the directional flow disk 46.

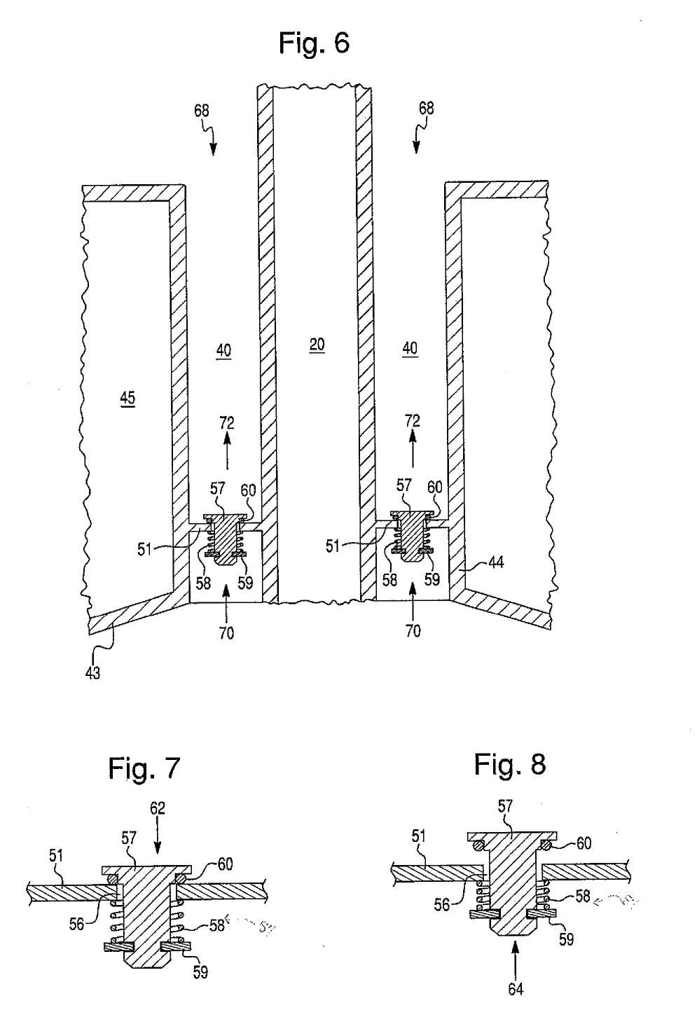

As best shown in FIGS. 5 and 6, the annular channel 40 extending through the center of the pod 12 may include a valve assembly 50. In some embodiments, the valve assembly 50 may comprise a partition 51 which extends across the interior annular channel 40 and blocks flow through the annular channel 40. The partition 51 may be integrally formed with the pod or may be a separate piece fit within the channel. If the partition comprises a separate piece, inner and outer O-rings may be utilized to prevent leakage between the riser tube 20b and the partition 51 and the interior wall 42 and the partition 51, respectively. The partition 51 may include at least one valve 54 seated in an opening 56 in the partition 51. For example, the partition may include two or more valves e.g., three, four, or even more valves seated in openings. The valve 54 preferably comprises a calibrated or pressure sensitive one-way check valve which only allows fluid to flow through the valve 54 in a single direction. For example, in some embodiments, the valve 54 may comprise a spring-loaded plunger valve of the type that is well known in the art. As shown in FIGS. 7 and 8, the valve 54 is comprised of a plunger 57, a spring 58, a retaining clip 59, and an O-ring 60. When fluid pressure is applied in the direction of the arrow 62 the plunger 57 lodges in the opening 56 so that fluid is not allowed to pass through the opening 56. When fluid pressure is applied in the direction of the arrow 64, the plunger 57 is forced upwards, allowing fluid to flow through the opening 56.

Although a spring loaded plunger valve 54 is shown in FIGS. 6 and 7, any type of mechanical or electrical check-valve may be used. In an alternative embodiment, an electronic solenoid-controlled valve may be used to control the flow of fluid through the partition 51.

As best shown in FIG. 6, during a typical fluid treatment process, the valves 54 prevent the fluid from moving downwardly through the annular channel 40 in the direction of the arrow 68. However, the fluid may move upwardly in the direction of the arrow 70 when the pressure applied by the fluid in an upwardly direction 70 is sufficient to unseat the plunger 57 from the opening 56, as shown in FIG. 7.

In many embodiments, the pods 12 may also include a blending port 26 for adding or removing fluid from a pod. The blending ports may be variously configured. For example, the blending port may be in the form of a petcock. The diameter of the blending port may also vary depending on the size of the pods. In some embodiments, the blending port may have a diameter of from about 0.25 to about 1.0 inches. Advantageously, the blending port 26 enables an operator to add or remove a fluid at a specific phase in the treatment process. This option allows the operator to further customize the treatment of a particular fluid. For example, the chlorine from a municipal water supply may be removed by a pod 12 in the treatment device 10, but an operator may wish to blend a predetermined amount of chlorine (for example 10%) back into the treated water to attain a low level anti-bacterial effect. To create the desired blend, chlorinated water may be blended back into the treatment process through a pod blending port 26. Additionally or alternatively, a portion of the treated fluid may be withdrawn from the device 10 prior to passing through all of the pods 12. For example, a portion of the treated fluid may be withdrawn through a blending port 26 after passing through one or more pods 12, but prior to passing through a specific pod, e.g., a pod which removes chlorine, and the withdrawn fluid may be combined with the treated fluid removed via the outlet line 23. In this way, a desired blend may also be formed, for example, a treated fluid which contains a low level of chlorine. In many embodiments, the blending ports 26 may include a plug or valve, so that the blending port 26 only permits the passage of fluid when it is desired to add or remove fluid via a specific pod. Accordingly, all of the pods may be formed with a blending port 26, although they need not be, and the blending ports 26 of the individual pods 12 may be selectively utilized depending on a particular application. Through this process, the pods 12 and associated blending ports 26 significantly increase the flexibility of the device and treatment processes that can be performed.

The base unit 16 provides a stable support for the treatment device 10. In the preferred embodiment, the base unit 16 comprises an essentially concave sump which may be used as a reservoir for residual water that may be present after compressed air is driven through the device. Advantageously, the base unit can be easily removed and cleaned by an operator with minimal disturbance of the other components. Fluid is removed from the device 10 by extracting the fluid from the base unit 16, through the connected riser tubes 20, and out the fluid outlet line 23, as directed by the control valve arrangement 19.

In many embodiments, the base unit 16 may also include a plurality of leveling feet 29. The leveling feet 29 may be positioned around the perimeter of the base unit 16 and may be adjustable, e.g. may be capable of being extended or retracted, to compensate for an uneven surface on which the device 10 is placed. For example, the leveling feet 29 may be connected to the base unit 16 via screws which may be screwed farther into or out of the base unit 16 depending on the adjustment that is needed. The base unit 16 may include any number of leveling feet, for example, two, three, four, five or even more leveling feet 29.

The pods 12 may be connected to one another and to the head unit 14 and base unit 16 using a variety of connection mechanisms. In accordance with the present disclosure, the pods 12, head unit 14, and base unit 16 may be releasably connected to one another. In some embodiments, the connection mechanism may comprise a plurality of pairs of corresponding connecting tabs and slots. For example, connecting tabs 30 may be formed on an upper portion of each of the pods 12 and on an upper portion of the base unit and corresponding slots 32 may be formed on a lower portion of each of the pods 12 and a lower portion of the head unit 14. When the head unit 14 is seated on the uppermost pod 12, the connecting tab 30 on the pod 12 fits securely within the slot 32 in the head unit 14. When the uppermost pod 12 is seated on another pod 12 or on the base unit 16, the connecting tab 30 formed on the subsequent pod 12 or base unit 16 fits securely within the slot 32 formed in the uppermost pod 12. Alternatively, the slots may be formed on the upper portion of the pods 12 and the base unit 16 and the tabs may be formed on the lower portion of the pods 12 and the head unit 14. In many embodiments, the connecting tabs 30 and corresponding slots 32 are inclined, e.g., oriented at an angle with respect to the edge of the pod 12, head unit 14 or base unit 16 on which they are formed. For example, as seen most clearly in FIG. 4, a first end of the connecting tab 30 or corresponding slot 32 is disposed farther from the edge of the pod 12 (or head unit 14 or base unit 16) than a second end. In operation, a connecting tab and corresponding slot may be fitted together and the components which are being joined, e.g., two adjacent pods 12, a pod 12 and the head unit 14 and/or a pod 12 and the base unit 16 may be rotated in the direction of the upward incline of the tab and slot. Advantageously, as the components are rotated, the inclined slot and tab draw the two components together improving the connection between the components. Any number of connecting tabs 30 and slots 32 may be utilized. In some embodiments, the pods 12 and the base unit 16 may include four or more connecting tabs, for example, five, six, seven, eight, nine, ten or even more connecting tabs and the pods 12 and head unit 14 may include a corresponding number of slots.

In some embodiments, the connecting mechanism may also comprise a latch which connects one component to an adjacent component. As seen in FIGS. 4 and 5, the pods 12 and the head unit 14 may each include two vertically oriented, opposing brackets 80 which support a pivoting latch 82. The latch 82 may pivot into an upward, disengaged position or into a downward locked position. In many embodiments, the latch 82 may be pivoted into the downward locked position and engage an upper portion of an adjacent component. For example, a retention groove 84 may be formed in the latch and a corresponding ridge 86 may be formed on an upper portion of a pod 12 or the base unit 16. In the downward, locked position, the latch 82 extends beyond the component to which it is connected and engages the ridge 86 of the adjacent component. For example, the latch 82 on the head unit 14 may extend below the head unit 14 and engage the ridge 86 on the uppermost pod 12. In many embodiments, the ridges 86 on the pods 12 are formed between an upper portion of the opposing brackets 80. When the head unit 14 or a pod 12 is seated on a pod 12 and the latch 82 is pivoted into a downward, locked position, the latch 82 is disposed between the opposing brackets 80 of the adjacent component preventing or minimizing rotational movement of the pods 12. Alternatively, the latches may pivot into an upward locked position, engaging a lower portion of an adjacent component.

The connection mechanism may also include upper and lower seals, e.g., O-rings, gaskets or brackets, to ensure a fluid-tight seal between each of the pods 12 and the associated components.

Although the connecting mechanisms of some embodiments are described above, other types of connecting mechanisms should be considered within the scope of the invention. Specifically, any connecting mechanism known in the art may be used to secure each of the respective pods 12 to the head unit 14 and the base unit 16.

In operation, untreated fluid enters the device 10 through the fluid inlet line 21 and is directed across the surface of the wafer disk 13 or the uppermost pod 12, as applicable. Through gravitational migration and/or pressurized flow, the fluid moves through the wafer disk 13 (if present) and into the uppermost pod 12. The fluid then flows downwardly through the vertically arranged series of pods 12 comprising the treatment device 10.

As the fluid flows downwardly, the fluid establishes a flow path through each of the pods 12, whereby the fluid flows into an inlet side 41 of the pod 12 and is dispersed in a radial direction by the directional flow disk 46. The fluid flows into the annular treatment portion where it encounters the media present therein and then flows out an outlet side 43 of the pod 12. When the treated fluid reaches the base unit 16, the fluid is drawn into riser tube 20a of the base unit 16 and is extracted upwardly through the connected riser tubes 20 and out through the fluid outlet 23.

The treatment device 10 may be serviced by subjecting the components of the device 10 to a backwashing process. During the backwashing process, fluid is injected downwardly through the connected riser tubes 20. As the fluid injection continues, the fluid rises upwardly and establishes a first general flow path wherein the fluid level moves upwardly through the pods in the reverse order of the treatment process. When the fluid level reaches the head unit 14, the fluid is extracted from the device 10 through the head unit 14, as directed by the control valve arrangement 19.

As best shown in FIG. 6, in some embodiments, a secondary upward fluid path 72 in the direction of the arrow 70 may be established during the backwashing process. The secondary upward flow path 72 allows a portion of the backwash fluid to flow through the valve assemblies 50 of each pod 12 and the interior annular channel 40. This secondary fluid path 72 allows a portion of the backwash fluid to avoid the movement upwardly through each of the pods 12, and thereby prevents the repeated filtration of the backwash fluid inherent in the conventional backwash process. During the fluid treatment process, the valve assemblies 50 prevent fluid from flowing through the annular channel 40 in the direction of arrow 68 and bypassing the fluid treatment media.

By establishing dual flow paths through the treatment device 10, the media associated with each of the pods 12 is de-compacted and flushed, as is the case with the conventional backwashing process. However, because a significant amount of the backwash fluid is allowed to bypass the pod media 45 through the secondary flow path 72, less of the sediment is re-deposited in the next sequential pod 12, as the fluid moves upwardly through the device 10. The backwash method of the current invention allows more of the entrained sediment to be removed from the device 10, while simultaneously benefiting from the same de-compaction and flushing benefits realized from the conventional backwashing process.

In accordance with the present disclosure, backwashing processes may also be enhanced through the use of compressed air to purge a fluid treatment device prior to the initiation of the backwash process. For example, compressed air may be injected into a device so that an air cell is created. As more air is injected, the air cell enlarges and migrates downwardly from the top of the device, thereby displacing any fluid remaining in the device. The air injection process may be used at any time it is desired to remove fluid from a treatment device, for example, prior to servicing the device or after the completion of the backwashing process to ensure that backwashing fluid is purged from the device prior to the re-initiation of treatment operations.

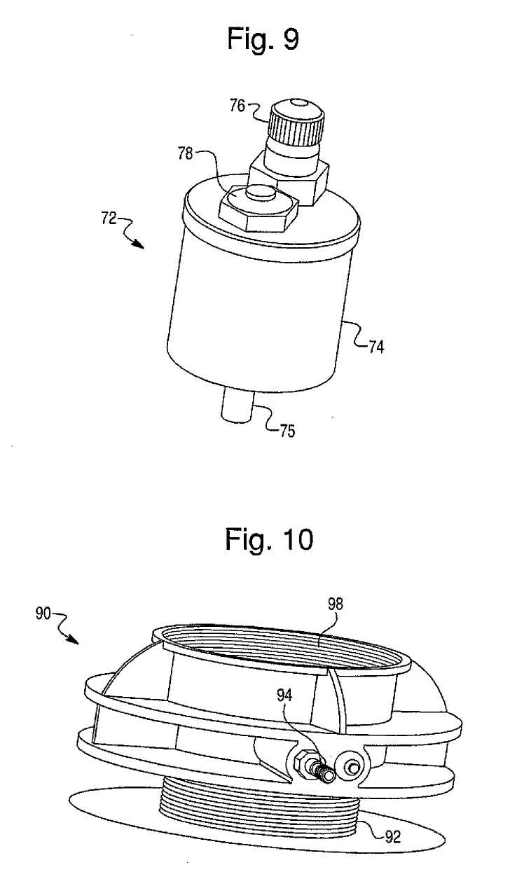

In some embodiments, a valve apparatus may be utilized for injecting compressed air into a fluid treatment device. Such a valve apparatus may have a variety of configurations. For example, in one embodiment, best shown in FIG. 9, a valve apparatus 72 may include a housing 74, a stem 75, and a compressed air inlet port 76, such as a standard Schrader valve, for selectively introducing compressed air into the valve 72. Additionally, the valve apparatus 72 may also include a pressure regulating blow-off function to ensure that the device is not over-pressurized during the air injection process. For example, in many embodiments, the valve 72 may include a pressure sensitive relief valve 78. The pressure sensitive relief valve 78 may be calibrated to release air from the system when a threshold pressure within a device is reached. In many embodiments, the valve apparatus may also include a one-way valve (not shown), for example, a ball and spring valve, to prevent untreated or treated fluid in the device from being removed through the valve apparatus 72.

The valve apparatus 72 may be configured to connect to a variety of standard fluid treatment vessels and/or filter housings. In one embodiment, the stem 75 may be configured to connect to the compressed air inlet port 24 (shown in FIG. 1) on the presently disclosed fluid treatment device 10. In other embodiments, the valve apparatus may not include a stem and may be connected to a fluid treatment device in other ways. For example, the valve apparatus 72 may be positioned in an interior of the device, such as in the head unit 14 and the compressed air inlet port 76 may project outside of the device. Advantageously, including the valve apparatus in the interior of the device provides for an improved connection between the valve and the device, as the internal pressure pushes the valve into connection with the device. Additionally or alternatively, the housing 74 may be sized to fit within conventional pipes or tubing used with standard fluid treatment devices. In one embodiment, the valve apparatus 72 may be positioned within a standard plumbing tee in a fluid line upstream of a fluid treatment device.

In another embodiment of a valve apparatus, best shown in FIG. 10, a valve apparatus 90 may include a standard compressed air inlet port 94, such as a standard Schrader valve and a pressure sensitive relief valve 96 as described above, but may be connected to a fluid treatment device between the head unit and a control valve arrangement. For example, the valve apparatus 90 may be connected to a fluid treatment vessel at the control valve connecting surface prior to connecting the control valve. Many fluid treatment devices, including the presently disclosed fluid treatment device, include internally threaded connecting surfaces for receiving the threaded stem of a control valve. The valve apparatus 90 advantageously includes a hollow threaded stem 92 which corresponds to the threaded stem of conventional control valves so that the apparatus may be conveniently connected at the control valve connecting surface. An opening in the valve apparatus 90 extending through the threaded stem 92 communicates with the head unit opening 17 for accommodating the head unit riser tube 20c, the inlet line 21, and the outlet line 23. In some embodiments, a riser tube extension may be used for extending the head unit riser tube through the valve apparatus 90. The valve apparatus 90 may also include an internally threaded connecting surface 98 for connecting to a control valve arrangement. The connecting surface 98 may accommodate any control valve arrangement and a number of standard control valves are available in the industry.

In operation, a valve apparatus for injecting compressed air into a fluid treatment device may allow compressed air to be selectively introduced into the fluid inlet side of a device through the air inlet port. For example, the air inlet port may communicate with the fluid inlet side of the pods 41. As the compressed air displaces fluid in the device, the fluid flows upwardly through the connected riser tubes through the valve apparatus, and out of the device 10 through the outlet line 23 as directed by the control valve arrangement.

The control valve arrangement 19 may contain any configuration of electrical and/or mechanical valves known in the art. In the preferred embodiment, the control valve arrangement 19 comprises electronically controlled automatic valves that include a programmable timer so that the valve arrangement 19 periodically shifts the device from a treatment mode, to a backwash mode, and then back into the treatment mode on an automated basis to ensure optimal performance of the treatment device. In alternative embodiments, the control valve arrangement 19 may be as simple as on/off valves attached to the fluid inlet 21 and fluid outlet 23 lines, or as complex as computer-actuated control mechanisms that interface with sensors monitoring the condition of the various treatment media and adjust the treatment process accordingly.

From the foregoing description it is clear that the presently disclosed fluid treatment device is an innovative stand-alone modular fluid treatment device that allows individual fluid treatment media modules to be removed and replaced with minimal disassembly of other modules in the device. The device is also extremely flexible and allows a user to uniquely tailor a fluid treatment process to their specific needs using a single pod or multiple pods and blending or removing fluid between the treatment pods. The device further is configured to allow a backwashing method that more effectively removes sediment from the treatment pods. The presently disclosed connecting arrangements for connecting a control valve to a fluid treatment device allows control valves to be consistently oriented as desired, while creating a fluid tight connection. The presently disclosed compressed air inlet valves advantageously allow for waterless service, without requiring complicated draining and siphoning.

The description of the preferred embodiments of the present invention has been presented for the purpose of illustration in accordance with the provisions of the Patent Statutes. It is not intended to be exhaustive or to limit the invention to the precise forms disclosed. For example, it is to be understood that while the description of the present invention has included references to water treatment, other types of fluids may also be treated using the described process.

Obvious modifications or variations are possible in light of the above teachings. The various aspects of the invention have been described with respect to many embodiments. However, the maximum invention is not limited to these embodiments. One or more of the features of any of these embodiments may be combined with one or more of the features of the other embodiments without departing from the scope of the invention. Further, one or more of the features of any of these embodiments may be modified or omitted without departing from the scope of the invention. For example, the presently disclosed modular fluid treatment devices wherein the individual components include riser tubes which connect to adjacent riser tubes may or may not include valve apparatuses for introducing compressed air and may or may not include a connecting mechanism for rotatably connecting a control valve arrangement. As another example, the individual components may be connected using one, both or neither of corresponding pairs of slots and tabs and the pivoting latches. Further, the directional flow disk, the connection mechanism for connecting a control valve to a fluid treatment device, and/or the valve apparatuses for introducing compressed air into a fluid treatment device may be used, singly or in combination with the presently disclosed fluid treatment device or with other available fluid treatment devices. Accordingly, the various aspects of the invention include all modifications encompassed within the spirit and scope of the invention as defined by the following claims.

What is claimed is:

1. A fluid treatment device comprising:
at least one fluid treatment pod having a rigid and impermeable outer wall and a rigid and impermeable inner wall defining an opening extending through an interior portion of the pod, a first rigid and impermeable riser tube extending through the opening, and a treatment media disposed in the pod interior portion, and
a hollow head unit having a second rigid and impermeable riser tube extending through an interior portion of the head unit, wherein the second riser tube is connected to an upper portion of the first riser tube to form a flow passage through the fluid treatment device.

2. The fluid treatment device of claim 1 wherein the fluid treatment device comprises a plurality of pods.

3. The fluid treatment device of claim 3 wherein the pods are releasably connected to one another via corresponding pairs of inclined slots and tabs.

4. The fluid treatment device of claim 3 wherein the pods are releasably connected to an adjacent pod via a pivoting latch including a retention groove which engages a corresponding ridge on an adjacent pod.

5. The fluid treatment device of claim 6 wherein the pivoting latch is retained between two opposing brackets on the adjacent pod to prevent counter-rotational movement of the pods.

6. The fluid treatment device of claim 1 wherein the at least one pod includes a blending port that allows fluid to be added and/or removed from the fluid treatment device.

7. The fluid treatment device of claim 1 further comprising a compressed air port formed in the head unit.

8. The fluid treatment device of claim 8 further comprising a compressed air inlet valve connected to the compressed air port, the compressed air valve including an inlet allowing compressed air to be selectively directed into the fluid treatment device and a pressure relief valve.

9. The fluid treatment device of claim 1 further comprising a base unit, the base unit including a third rigid and impermeable riser tube extending through an interior portion of the base unit, wherein the third riser tube is connected to a lower portion of an adjacent pod riser tube.

10. The fluid treatment device of claim 10 wherein the base unit further comprises one or more leveling feet.

11. The fluid treatment device of claim 1 wherein the head unit further comprises a connecting surface for connecting a control valve arrangement to the head unit riser tube, the connecting surface allowing the control valve arrangement to rotate 360°.

12. The fluid treatment device of claim 12 wherein the connecting surface comprises a yoke and a collar, the yoke configured to connect to a control valve arrangement riser and the collar being rotatable between a locked position which prevents the yoke from rotating and an unlocked position in which the yoke rotates.

13. The fluid treatment device of claim 1 wherein the first riser tube has a smaller outer diameter than a diameter of the opening to thereby define an annular passage between the pod and the riser, the device further comprising at least one valve assembly controlling movement of a fluid within the annular passage, wherein the valve assembly comprises a valve housing and at least one one-way valve disposed radially between the pod and the riser.

14. A connecting arrangement for rotatably connecting a control valve to a fluid treatment device comprising:
a yoke including an internally threaded sleeve for receiving a threaded control valve stem, a riser tube extending through the sleeve, and a lip surrounding the sleeve, the lip comprising a first portion and a second portion, the first portion having an outer diameter greater than an outer diameter of the second portion,
and a threaded collar including a flange extending inwardly and defining an aperture through which the threaded sleeve extends, the flange engaging the lip first portion when the collar is threadedly connected to the fluid treatment device.

15. A valve apparatus for introducing compressed air into a fluid treatment device comprising: a housing; a compressed air inlet valve allowing compressed air to be selectively directed into the valve apparatus; a pressure relief valve for selectively releasing air from the valve apparatus; and a one-way valve for controlling the movement of fluid out of the valve apparatus.

16. The valve apparatus of claim 15 further comprising a threaded stem and a threaded opening for connecting the apparatus between the fluid treatment device and a control valve.

17. The valve apparatus according to claim 15 wherein the housing is sized to fit within a standard plumbing tee.

18. A flow diversion element for controlling a flow path in a fluid treatment device comprising an annular disk having an inner circumference and an outer circumference and a top surface and a bottom surface and a plurality of fins extending from the top surface to the bottom surface and defining a plurality of flow passages through the disk, each of the fins extending from the inner circumference or the outer circumference in a radial or tangential direction different from the radial or tangential direction of at least one other fin.

19. The flow diversion element of claim 18 wherein the annular disk is divided into quadrants, each quadrant including fins extending in two or more radial or tangential directions and the fins in each quadrant extend in a radial or tangential direction different from the radial or tangential direction of fins in another quadrant.

20. The flow diversion element of claim 19 wherein one quadrant includes fins oriented concentrically with the outer circumference of the pod and fins radiating from the inner circumference to the outer circumference and another quadrant includes fins oriented parallel to a first bi-section of the pod and fins oriented parallel to another bi-section of the pod and perpendicular to the other fins in the quadrant.
